(19) United States
(12) Patent Application Publication
(10) Pub. No.: US 2001/0032174 A1
(43) Pub. Date: Oct. 18, 2001

(54) Network transacting method using a data processing system

(76) Inventor: Takashi Yokota, Tokyo (JP)

Correspondence Address: McGinn & Gibb, PLLC, Suite 200, 8321 Old Courthouse Road, Vienna, VA, 22182-3817, US

(21) Appl. No.: 09/834,625

(22) Filed: Apr. 16, 2001

(30) Foreign Application Priority Data
Apr. 17, 2000 (JP) 115266/2000

(51) Int. Cl. G06F 17/60

(52) U.S. Cl. 705/37

(57) ABSTRACT

A network transacting method uses a data processing system in which terminal units are interconnected via a communication network for interchanging data with each other. A trader presents data representative of an industrial or an intellectual property purchase offer in the form of, e.g., a homepage, which can be freely browsed via the communication network. When the trader desires to purchase an industrial or an intellectual property from a seller, the trader accesses a search server installed in a Patent Office to see if the property and seller are licit. On purchasing the intellectual property, the trader applies for the registration of the property at the Patent Office and then presents the purchased property to a buyer. In addition, the trader takes proceedings for the transfer of the property at the Patent Office. The method promotes a broad range of industrial property and intellectual property transactions while freeing sellers and buyers from troublesome legal procedures.

### BACKGROUND OF THE INVENTION

The present invention relates to a network transacting method using a data processing system, in which terminal units are interconnected via Internet or similar communication network for interchanging data with each other, and promoting easy transactions relating to industrial properties and intellectual properties.

Today, the spread of Internet, which is a specific communication network, has derived network transactions that allow buyers and sellers to negotiate with each other by data communication via Internet. With Internet transactions, even individuals can easily join in the sale and purchase of various articles by browsing homepages that mediate between persons. Generally, a seller intending to sell articles registers various informations relating to the articles at a homepage. A buyer found the articles by browsing the seller's homepage contacts the seller and then purchases the articles. Further, it is a common practice for a broker to present a purchase offer on a homepage, purchase articles from a seller who browsed the homepage, register information relating to the articles on the homepage, and sell the articles to a buyer who also browsed the homepage.

The network transactions allow even an individual to personally sell and purchase desired articles and therefore contribute a great deal to the recycling of resources. Not only household appliances and other articles that occupy space, but also real estate, stock certificates, services and so forth that do not occupy space are the subjects of network transactions. However, industrial properties including patent rights and intellectual properties including inventions not applied are not commonly dealt with.

Particularly, the contents of pending patent applications and those of inventions applied, but not laid open for public inspection, are not open to the public. This prevents individual inventors or applicants from easily presenting and selling inventions to, e.g., industries. For example, assume that an individual inventor files an application for a patent at a Patent Office and then sells the invention to an industry, the industry must determine whether or not the inventor or seller licitly owns the invention and must take, when purchased the invention, proceedings for the transfer of the right for application at the Patent Office. Such a procedure is troublesome to take.

On the other hand, there is little chance for an individual to purchase a patent right owned by another individual. Even if transactions between individuals are successful, it is extremely troublesome for an individual to make the above decision and take the necessary proceedings. Further, it is not desirable from the secrecy standpoint to present and sell an invention not applied for a patent, i.e., at the level of an idea to an industry or an individual. Also, it is not practical to apply all inventions for a patent at the level of an ideal.

### SUMMARY OF THE INVENTION

It is therefore an object of the present invention to provide a network transacting method using a data processing system, in which terminals units are interconnected via a communication network for interchanging data with each other, and facilitating the sale and purchase of industrial properties and intellectual properties.

It is another object of the present invention to provide a data processing system for the network transacting method, a terminal unit, and a data storing medium storing a program to be executed by the computer of the terminal unit in the form of software. In accordance with the present invention, a network transacting method uses a data processing system in which a plurality of terminal units each having at least a data inputting function, a data outputting function and a data communicating function are connected to a communication network for interchanging data with each other. The method begins with the step of causing a trader to present data representative of a purchase offer meant for an industrial property managed by a search server, which is one of the terminal units and installed in a Patent Office, via the trader's terminal unit such that the data can be freely browsed via the communication network. The trader's terminal unit accepts an sale offer meant for the industrial property and received from a seller's terminal unit. The trader's terminal unit references the search server via the communication network to see if the industrial property to be sold and seller are licit and purchases, if the industrial property and seller are licit, the industrial property from the seller. The trader then takes proceedings for the transfer of the industrial property from the seller to the trader at the Patent Office, and registers information relating to the industrial property transferred at the trader's terminal unit. Subsequently, the trader presents a sale offer meant for the industrial property registered to a buyer's terminal unit via the trader's terminal unit, and accepts a purchase offer meant for the industrial property and received from a buyer via the buyer's terminal unit. Thereafter, the trader sells the industrial property to the buyer and takes proceedings for the transfer of the industrial property from the trader to the buyer at the Patent Office.

Also, in accordance with the present invention, a data processing method is applied to any one of a plurality of terminal units included in a data processing system in which the terminal units, each of which has at least a data inputting function, a data outputting function and a data communicating function, are connected to a communication network for interchanging data with each other. The method begins with the step of presenting data representative of a purchase offer meant for an industrial property managed by a search server, which is one of the terminal units and installed in a Patent Office, such that the data can be freely browsed via the communication network. A sale offer meant for the industrial property and received from a seller's terminal unit is accepted. The search server is referenced via the communication network to see if the industrial property to be sold and seller are licit. If the industrial property and seller are licit, information relating to the industrial property purchased from the seller are registered. A sale offer meant for the industrial property registered is presented to a buyer's terminal unit. A purchase offer meant for the industrial property and received from a buyer via the buyer's terminal unit is accepted.

Further, in accordance with the present invention, a terminal unit is included in a data processing system in which a plurality of terminal units, each of which has at least a data inputting function, a data outputting function and a data communicating function, are connected to a communication network for interchanging data with each other. The terminal unit includes a purchase presenting function for presenting data representative of a purchase offer meant for an industrial property managed by a search server, which is one of the plurality of terminal units and installed in a Patent Office, such that the data can be freely browsed via the communication network. A sale accepting function accepts a sale offer meant for the industrial property and received from a seller's terminal unit. An authenticating function references the search server via the communication network to see if the industrial property to be sold and seller are licit. An information registering function registers, if the industrial property and seller are licit, information relating to the industrial property purchased from the seller. A sale presenting function presents a sale offer meant for the industrial property registered to a buyer's terminal unit. A purchase accepting function accepts a purchase offer meant for the industrial property and received from a buyer via the buyer's terminal unit.

Moreover, in accordance with the present invention, a data storing medium stores a program for causing a computer included in a terminal unit included in a data processing system in which a plurality of terminal units, each of which has at least a data inputting function, a data outputting function and a data communicating function, are connected to a communication network for interchanging data with each other, to executing the following procedure:

presenting data representative of a purchase offer meant for an industrial property managed by a search server, which is one of the plurality of terminal units and installed in a Patent Office, such that the data can be freely browsed via the communication network;

accepting a sale offer received meant for the industrial property from a seller's terminal unit;

referencing the search server via the communication network to see if the industrial property to be sold and seller are licit;

registering, if the industrial property and seller are licit, information relating to the industrial property purchased from the seller;

presenting a sale offer meant for the industrial property registered to a buyer's terminal unit; and

accepting a purchase offer meant for the industrial property and received from a buyer via the buyer's terminal unit.

### BRIEF DESCRIPTION OF THE DRAWINGS

The above and other objects, features and advantages of the present invention will become more apparent from the following detailed description taken with the accompanying drawings in which:

FIG. 1 is a schematic block diagram showing the physical structure of a data processing system embodying the present invention;

FIG. 2 is a schematic block diagram showing a specific physical configuration of a trader's terminal unit included in the illustrative embodiment;

FIG. 3 is a schematic block diagram showing a specific logical configuration of the trader's terminal; and

FIG. 4 is a flowchart demonstrating a specific network transacting method unique to the illustrative embodiment.

### DESCRIPTION OF THE PREFERRED EMBODIMENT

Industrial properties referred to hereinafter include patents, utility models, designs and trademarks as well as pending applications and applications not laid open for public inspection. On the other hand, intellectual properties also referred to hereinafter include ideas not applied for a patent, utility mode, design or trademark as well as copyrights. Of course, industrial properties and intellectual properties include all of commonly defined rights.

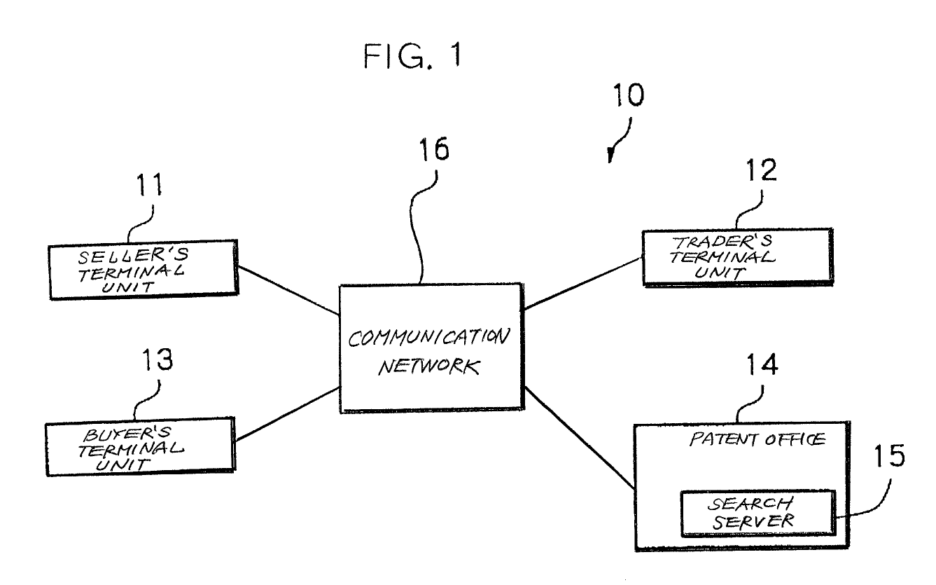

Referring to FIG. 1 of the drawings, a data processing system embodying the present invention is shown and applied to patents and pending patent applications by way of example. As shown, the data processing system, generally 10, includes a seller's terminal unit 11 controlled by any seller, a trader's terminal unit 12 controlled by a broker or similar trader, a buyer's terminal unit 13 controlled by any buyer, and a search server 15, which is a terminal unit installed in a Patent Office 14. The terminal units 11 through 15 are interconnected via a communication network 16.

The search server 15 in the Patent Office 14 manages property data relating to patents and pending patent applications. The user of anyone of the terminals 11 through 13 can browse the property data managed by the search server 15 via the communication network 16, as desired.

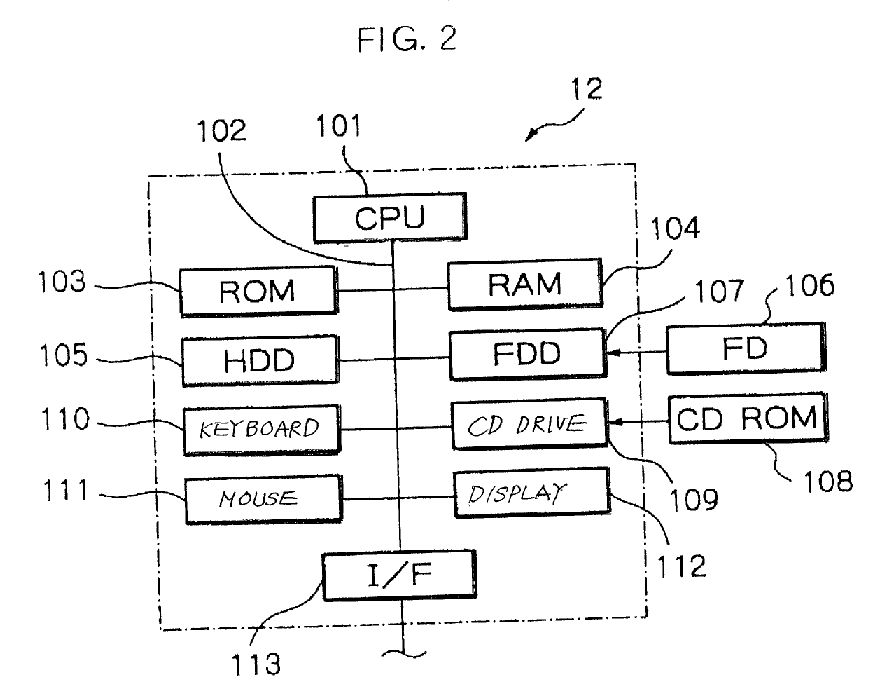

The terminal units 11 through 13 and search server 15 each are implemented by, e.g., a personal computer and capable of at least inputting and outputting data and interchanging data. FIG. 2 shows a specific configuration of the trader's terminal unit 12 by way of example. As shown, the terminal unit 12 includes a CPU (Central Processing Unit) 101, which is software constituting major part of a computer. A bus line 102 connects various hardware components to the CPU 101. The hardware components include a ROM (Read Only Memory) 103, a RAM (Random Access Memory), a HDD (Hard Disk Drive), a FDD (Floppy Disk Drive) 107, a CD (Compact Disk) drive 109, a keyboard 110, a mouse 111, a display 112, and a communication interface (I/F) 113. The communication I/F 113 is connected to the communication network 16. A floppy disk 106 is replaceably mounted to the FDD 107 while a CD-ROM 108 is replaceably mounted to the CD drive 109.

The seller's terminal unit 11, buyer's terminal unit 13 and search server 15 are basically identical with the trader's terminal 12 as to hardware configuration. In the following description, identical hardware components will be designated by identical names and identical reference numerals and will not be described specifically in order to avoid redundancy.

In the illustrative embodiment, the ROM 103, RAM 104, HDD 105, replaceable FD 106 and replaceable CD-ROM 108 included in each of the terminal units 11 through 13 play the role of data storing media. At least one of such data storing media stores a control program for executing various operations together with various information, i.e., software. Specifically, a control program necessary for the CPU 101 to execute various procedures is stored in, e.g., the FD 106 or the CD-ROM 108 beforehand. Such software is installed in the HDD 106 beforehand. On the startup of the data processing system 10, the software stored in the HDD 105 is copied in the RAM 104 and then read by the CPU 101.

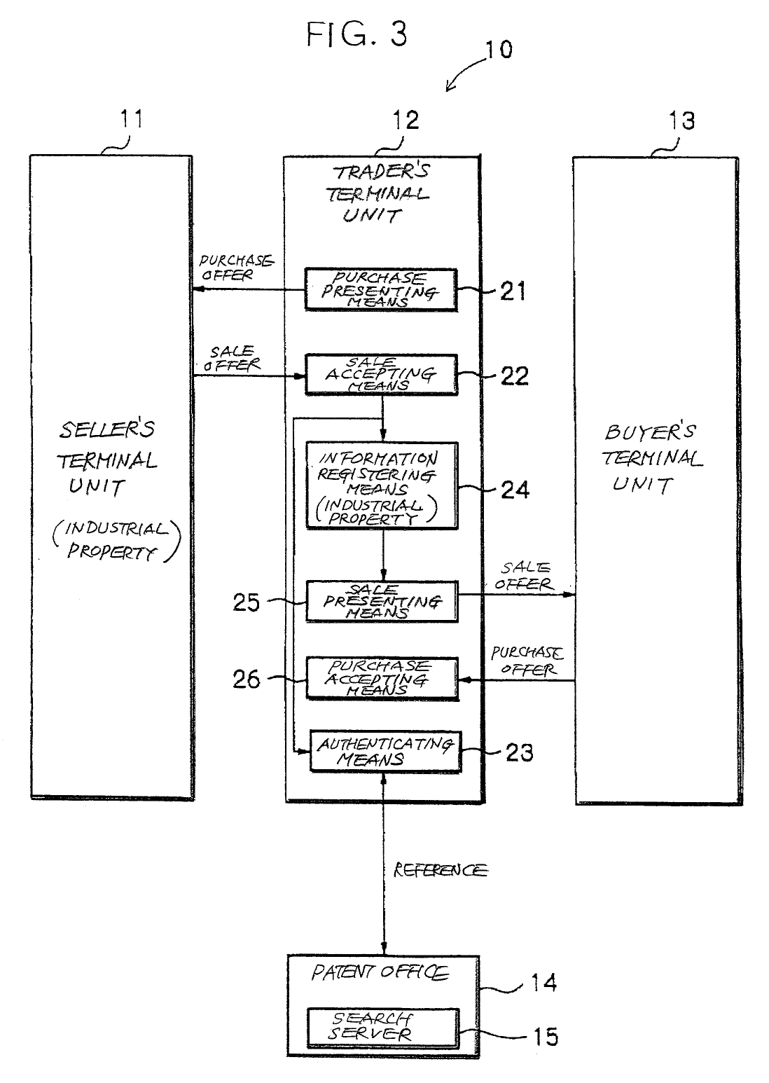

FIG. 3 shows specific means, or functions, logically implemented in the trader's terminal unit 12 and including purchase presenting means 21, sale accepting means 22, authenticating means 23, information registering means 24, sale presenting means 25, and purchase accepting means 26. These means 21 through 26 can be implemented by the CPU 101 that adequately reads the program and executes various procedures.

With the purchase presenting means 21, the CPU 101 reads a data file out of, e.g., the HDD 105 in accordance with the control program stored in the RAM 104 and sends it via the communication I/F 113 in the form of data. The purchase presenting means 21 therefore allows a purchase offer relating to an industrial property to be presented such that it can be browsed via the communication network 16.

With the purchase accepting means 22, the CPU 101 recognizes data received via the communication I/F 113 in accordance with the control program stored in the RAM 104. More specifically, the purchase accepting means 22 receives a sale offer from the seller's terminal unit 11 in the form of data.

As stated above, the presentation of data representative of a purchase offer and the receipt of data representative of a sale offer resemble the browsing of a homepage on Internet. Specifically, when the seller at the terminal unit 11 accesses the homepage of the trader's terminal unit 12, a picture listing purchase offers relating to industrial properties appears on the display 112 of the seller's terminal unit 11. The seller, watching the above picture on the display 112, fills necessary items included in the picture with desired information on the terminal unit 11. As a result, the trader's terminal unit 12 received data representative of a sale offer from the seller's terminal unit 11.

With the authenticating means 23, the CPU 101 executes preselected data communication via the communication I/F 113 in accordance with the control program stored in the RAM 104. Specifically, the authenticating means 23 references the search server 15 of the Patent Office 14 via the communication network 16 to see if the industrial property to be sold and the seller are licit. While the trader's terminal 12 executes this operation substantially automatically, it may alternatively urge the trader to perform intentional authentication.

The information registering means 24 corresponds to the storage area of, e.g., the HDD 105 for storing a data file in a format that the CPU 101 can recognize. Specifically, the information registering means 24 stores the various information of the industrial property, which the trader purchased from the authenticated seller, as a data file having a preselected format.

With the sale presenting means 25, the CPU 101 sends the data file stored in, e.g., the HDD 105 via the communication I/F 113 in a preselected data format in accordance with the control program stored in the RAM 104. The sale presenting means 25 therefore allows the sale offer registered at the information registering means 24 to be presented to the buyer's terminal unit 13 via the communication network 16.

With the purchase accepting means 26, the CPU 101 recognizes data received via the communication I/F in accordance with the control program stored in the RAM 104. More specifically, the purchase accepting means 26 receives a purchase offer from the buyer's terminal unit 13 via the communication network 13 in the form of data.

In the illustrative embodiment, the sale presenting means 25 presents the sale offer to the buyer's terminal unit 13, which is registered beforehand, by electronic mail. Also, the purchase accepting means receives data on the basis of a returning function available with electronic mail.

As stated above, the various means 21 through 26 of the trader's terminal unit 12 are implemented by the HDD 105, communication I/F 113 and other hardware components, as needed. However, the major component is the CPU 101 operable in accordance with the software stored in the RAM 104 or similar data storing medium. The software causes the CPU 101 to execute various kinds of procedures including the following procedure (a) through (f):

(a) presenting a purchase offer relating to an industrial property and received from the buyer's terminal unit 13 in the form of a homepage to be browsed via the communication network 16;

(b) receiving a sale offer from the seller's terminal unit 11 in the form of data filled in, e.g., the homepage;

(c) referencing the search server 15 of the Patent Office 14 via the communication network 16 to see if the industrial property to be sold and the seller are licit;

(d) registering the various information of the industrial property purchased from the licit seller at, e.g., the HDD 105 as a data file having a preselected format;

(e) presenting the sale offer to the buyer's terminal unit 13 by, e.g., electronic mail; and

(f) receiving a purchase offer from the buyer s terminal unit 13 by, e.g., electronic mail.

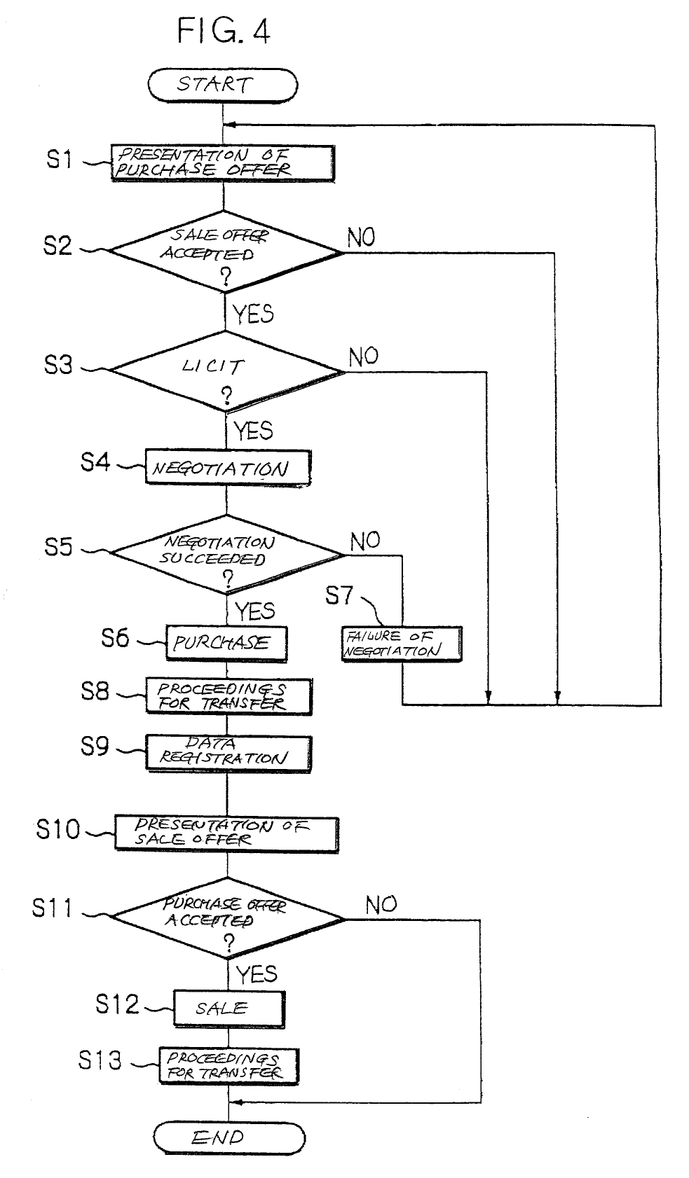

Reference will be made to FIG. 4 for describing a specific network trading method available with the illustrative embodiment. First, the trader makes a contract with a plurality of buyers and registers the mail addresses of the buyers' terminal units 13 at the trader's terminal unit 12. The trader then builds a homepage for presenting data representative of purchase offers meant for industrial properties and makes the homepage browsable via the communication network or Internet 16.

Subsequently, assume that the seller browses the homepage of the trader's terminal unit 12 via the communication network 16 by operating the seller's terminal unit 11. Then, as shown in FIG. 4, the trader's terminal unit 12 displays its homepage showing a purchase offer on the display 112 in the form of data (step S1). If the seller owns an industrial property to sell, then the seller inputs a sale offer on the home page in the form of data. The sale offer is sent from the seller's terminal unit 11 to the trader's terminal unit 12 via the communication network 16.

The trader's terminal determines whether or not it has received the sale offer (step S2). If the answer of the step S2 is positive (Y), the trader's terminal unit 12 accesses the search server 15 of the Patent Office 14 via the communication network 16 to see if the industrial property to be sold and the seller are licitly related (step S3). If the answer of the step S3 is positive (Y), the trader negotiates with the seller in consideration of the various input information (step S4). Only if the negotiation is successful (Y, step S5), the trader purchases the industrial property from the seller (step S6) and then takes proceedings for the transfer of the industrial property at the Patent Office 14 (step S8). If the answer of the step S5 is negative (N), the operation returns to the step S1, determining that the negotiation failed (step S7). This is also true when the answer of the step S2 or S3 is N.

The trader purchased the industrial property registers the various information of the industrial property at the terminal unit 12 (step S9). The trader then presents a sale offer relating to the industrial property to the registered buyer's terminal unit 13 by, e.g., electronic mail (step S10). Assume that the buyer informed of the sale offer desires to purchase the industrial property in consideration of its contents. The buyer then sends a purchase offer to the trader's terminal unit 12 via the buyer's terminal unit 13 by, e.g., electronic mail.

On receiving the purchase offer (Y, step S11), the trader sells the industrial property to the buyer via the trader's terminal unit 12 (step S12). Again, the trader takes proceedings for the transfer of the industrial property at the Patent Office 14 (step S13). If the answer of the step S11 is N, then the operation ends.

In the illustrative embodiment, data representative of purchase offers are constantly presented (step S1). By contrast, data representative of sale offers are presented when the trader purchases an industrial property or makes a contract with a new subscriber (step S10).

The data processing system 10 described above allows patents and other industrial properties to be sold and purchased via the communication network 16. Particularly, the system 10 presents purchase offers in the form of, e.g., an Internet homepage that can be freely browsed, allowing even an individual inventor to purchase industrial properties.

Further, the trader, intending to purchase an industrial property from the seller, accesses the search server 15 of the Patent Office via the communication network 16 to see if the industrial property and the seller are licitly related. The trader can therefore purchase only an adequate industrial property from the seller.

Moreover, the trader can adequately present the industrial property purchased only to organizations or similar registered subscribers by, e.g., electronic mail while insuring secrecy. In addition, the trader takes proceedings for the transfer of the industrial property at the Patent Office so as to free both of the seller and buyer from troublesome procedures, promoting easy sale and purchase.

While the illustrative embodiment has concentrated on patents and pending patent applications, it is, of course, applicable to intellectual properties. Specifically, the trader may present an intellectual property purchase offer on the trader's terminal unit 12 in the form of data that can be freely browsed via the communication network 16, negotiate with the seller who sent a sale offer via the seller's terminal unit 11, and purchase an intellectual property from the seller. Thereafter, the trader may file an application for, e.g., a patent at the Patent Office 14 and then sell the intellectual property. The trader can therefore collect a broad range of intellectual properties not applied for a patent at the Patent Office 14 and then file applications at the Patent Office 14. Again, the trader takes proceedings for the transfer of the intellectual property at the Patent Office so as to free the seller and buyer from troublesome procedures, promoting easy sale and purchase.

In the illustrative embodiment, the CPU 101 operates in accordance with the control program stored in, e.g., the RAM 104 as software and thereby logically implements the various functions of the trader's terminal unit 12. Alternatively, the various functions may be implemented by independent hardware each or may be partly implemented by software and stored in, e.g., the RAM 104 and partly implemented by hardware.

In the illustrative embodiment, at the startup of the trader's terminal unit 12, the software installed in the HDD 105 via, e.g., the CD-ROM 108 beforehand is copied in the RAM 104 and then read by the CPU 101. If desired, the software may not be copied in the RAM 104 or may be fixedly stored in the ROM 103 beforehand.

The software may be stored in the FD 106 or the CD-ROM 108, which is a removable data storing medium, beforehand and then installed in the HDD 105 or the RAM 104. Alternatively, the CPU 101 may directly read the software stored in the FD 106 or the CD-ROM 108 without the intermediary of the HDD 105 or the RAM 104. The crux is that when the various functions of the trader's terminal unit 12 are implemented by software, the CPU 101 can read the software and execute processing in accordance with the software.

Furthermore, the control program for implementing the various functions of the trader's terminal unit 12 may be constituted by a combination of different software. In such a case, the removable data storing medium 106 or 108 should only store a minimum amount of software necessary for realizing the trader's terminal unit 12. For example, assume that application software stored in the CD-ROM 108 or similar removable data recording medium is loaded in the trader's terminal unit 12 in which an operating system is installed beforehand. Then, the various functions of the trader's terminal unit 12 are implemented by the combination of the application software and operating system. This makes it needless for CD-ROM 108 to store part of the software that depends on the operating system.

In summary, it will be seen that the present invention provides a network transacting method using a data processing system and having various unprecedented advantages, as enumerated below.

(1) A broker or similar trader presents purchase offers meant for industrial properties or intellectual properties in the form of, e.g., an Internet homepage, which is free to browse, via the trader's terminal unit. The trader can therefore collect purchase offers even from individuals.

(2) When the trader purchases, e.g., an industrial property from a seller, the trader accesses a search server installed at a Patent Office via a communication network to see if the industrial property and seller are licitly related. The trader can therefore purchase only adequate industrial properties from sellers.

(3) The trader purchased an intellectual property from a seller is capable of applying for the registration of the intellectual property at the Patent Office. This frees the seller and a buyer from troublesome proceedings for the application.

(4) The trader presents industrial properties that the trader purchased in the form of data, and can therefore collect buyers.

(5) The trader takes necessary proceedings for the transfer of an industrial property at the Patent Office. This also frees a seller and a buyer from troublesome proceedings and thereby promotes easy sale and purchase of industrial properties or intellectual properties.

Various modifications will become possible for those skilled in the art after receiving the teachings of the present disclosure without departing from the scope thereof.

What is claimed is:

1. A network transacting method using a data processing system in which a plurality of terminal units each having at least a data inputting function, a data outputting function and a data communicating function are connected to a communication network for interchanging data with each other, said network transacting method comprising the steps of:
causing a trader to present data representative of a purchase offer meant for an industrial property managed by a search server, which is one of the plurality of terminal units and installed in a Patent Office, via a trader's terminal unit such that said data can be freely browsed via the communication network;
causing the trader's terminal unit to accept an sale offer meant for the industrial property and received from a seller's terminal unit;
causing the trader's terminal unit to reference the search server via the communication network to see if the industrial property to be sold and the seller are licit;
causing, if the industrial property and the seller are licit, the trader to purchase the industrial property from the seller;
causing the trader to take proceedings for a transfer of the industrial property from the seller to said trader at the Patent Office;
causing the trader to register information relating to the industrial property transferred at the trader's terminal unit;
causing the trader to present a sale offer meant for the industrial property registered to a buyer's terminal unit via the trader's terminal unit;
causing the trader's terminal unit to accept a purchase offer meant for the industrial property and received from a buyer via the buyer's terminal unit;
causing the trader to sell the industrial property to the buyer; and
causing the trader to take proceedings for a transfer of the industrial property from the trader to the buyer at the Patent Office.

2. A network transacting method using a data processing system in which a plurality of terminal units each having at least a data inputting function, a data outputting function and a data communicating function are connected to a communication network for interchanging data with each other, said network transacting method comprising the steps of:
causing a trader to present data representative of a purchase offer meant for an intellectual property via a trader's terminal unit such that said data can be freely browsed via the communication network;
causing the trader's terminal unit to accept a sale offer meant for the intellectual property and received from a seller's terminal unit;
causing the trader to purchase the intellectual property from the seller;
causing the trader to apply for a registration of the intellectual property purchased at a Patent Office;
causing the trader to register information relating to the intellectual property applied for the registration at the trader's terminal unit;
causing the trader to present a sale offer meant for the intellectual property registered to a buyer's terminal unit via the trader's terminal unit;
causing the trader's terminal unit to accept a purchase offer meant for the intellectual property and received from a buyer via the buyer's terminal unit;
causing the trader to sell the intellectual property to the buyer; and
causing the trader to take proceedings for a transfer of the intellectual property from the trader to the buyer at the Patent Office.

3. A network transacting method using a data processing system in which a plurality of terminal units each having at least a data inputting function, a data outputting function and a data communicating function are connected to a communication network for interchanging data with each other, said network transacting method comprising the steps of:
causing a trader to present data representative of a purchase offer meant for an industrial property of an intellectual property managed by a search server, which is one of the plurality of terminal units and installed in a Patent Office, via a trader's terminal unit such that said data can be freely browsed via the communication network;
causing the trader's terminal unit to accept a sale offer meant for the industrial property or the intellectual property and received from a seller's terminal unit;
causing the trader's terminal unit to reference the search server via the communication network to see if he industrial property to be sold and the seller are licit;
causing, if the industrial property and the seller are licit, the trader to purchase the industrial property from the seller;
causing the trader to take proceedings for a transfer of the industrial property from the seller to said trader at the Patent Office;
causing the trader to purchase the intellectual property from the seller;
causing the trader to apply for a registration of the intellectual property purchased at the Patent Office;
causing the trader to register information relating to the industrial property or the intellectual property purchased at the trader's terminal unit;
causing the trader to present a sale offer meant for the industrial property or the intellectual property to a buyer's terminal unit via the trader's terminal unit;
causing the trader's terminal unit to accept a purchase offer meant for the industrial property or the intellectual property and received from a buyer via the buyer's terminal unit;
causing the trader to sell the industrial property or the intellectual property to the buyer; and
causing the trader to take proceedings for a transfer of the industrial property or the intellectual property from the trader to the buyer at the Patent Office.

4. A data processing method for any one of a plurality of terminal units included in a data processing system in which said plurality of terminal units, each of which has at least a data inputting function, a data outputting function and a data communicating function, are connected to a communication network for interchanging data with each other, said data processing method comprising the steps of:
presenting data representative of a purchase offer meant for an industrial property managed by a search server, which is one of the plurality of terminal units and installed in a Patent Office, such that said data can be freely browsed via the communication network;
accepting a sale offer meant for the industrial property and received from a seller's terminal unit;
referencing the search server via the communication network to see if the industrial property to be sold and the seller are licit;
registering, if the industrial property and the seller are licit, information relating to said industrial property purchased from the seller;
presenting a sale offer meant for the industrial property registered to a buyer's terminal unit; and
accepting a purchase offer meant for the industrial property and received from a buyer via the buyer's terminal unit.

5. A data processing method for any one of a plurality of terminal units included in a data processing system in which said plurality of terminal units, each of which has at least a data inputting function, a data outputting function and a data communicating function, are connected to a communication network for interchanging data with each other, said data processing method comprising the steps of:
presenting data representative of a purchase offer meant for an intellectual property such that said data can be freely browsed via the communication network;
accepting a sale offer meant for the industrial property and received from a seller's terminal unit;
registering information relating to the intellectual property purchased from the seller and applied for a registration;
presenting a sale offer meant for the intellectual property registered to a buyer's terminal unit; and
accepting a purchase offer meant for the intellectual property and received from a buyer via the buyer's terminal unit.

6. A terminal unit included in a data processing system in which a plurality of terminal units, each of which has at least a data inputting function, a data outputting function and a data communicating function, are connected to a communication network for interchanging data with each other, said terminal unit comprising:
purchase presenting means for presenting data representative of a purchase offer meant for an industrial property managed by a search server, which is one of the plurality of terminal units and installed in a Patent Office, such that said data can be freely browsed via the communication network;
sale accepting means for accepting a sale offer meant for the industrial property and received from a seller's terminal unit;
authenticating means for referencing the search server via the communication network to see if the industrial property to be sold and the seller are licit;
information registering means for registering, if the industrial property and the seller are licit, information relating to said industrial property purchased from said seller;
sale presenting means for presenting a sale offer meant for the industrial property registered to a buyer's terminal unit; and
a purchase accepting means for accepting a purchase offer meant for the industrial property and received from a buyer via the buyer's terminal unit.

7. A terminal unit included in a data processing system in which a plurality of terminal units, each of which has at least a data inputting function, a data outputting function and a data communicating function, are connected to a communication network for interchanging data with each other, said terminal unit comprising:
purchase presenting means for presenting data representative of a purchase offer meant for an intellectual property such that said data can be freely browsed via the communication network;
sale accepting means for accepting a sale offer meant for the intellectual property and received from a seller's terminal unit;
information registering means for registering information relating to the intellectual property purchased from the seller and applied for a registration;
sale presenting means for presenting a sale offer meant for the intellectual property registered to a buyer's terminal unit; and
purchase accepting means for accepting a purchase offer meant for the intellectual property and received from a buyer via the buyer's terminal unit.

8. A data storing medium storing a program for causing a computer included in a terminal unit included in a data processing system in which a plurality of terminal units, each of which has at least a data inputting function, a data outputting function and a data communicating function, are connected to a communication network for interchanging data with each other, to executing a following procedure:
presenting data representative of a purchase offer meant for an industrial property managed by a search server, which is one of the plurality of terminal units and installed in a Patent Office, such that said data can be freely browsed via the communication network;
accepting a sale offer received meant for the industrial property from a seller's terminal unit;
referencing the search server via the communication network to see if the industrial property to be sold and the seller are licit;
registering, if the industrial property and the seller are licit, information relating to said industrial property purchased from said seller;
presenting a sale offer meant for the industrial property registered to a buyer's terminal unit; and
accepting a purchase offer meant for the industrial property and received from a buyer via the buyer's terminal unit.

9. A data storing medium storing a program for causing a computer included in a terminal unit included in a data processing system in which a plurality of terminal units, each of which has at least a data inputting function, a data outputting function and a data communicating function, are connected to a communication network for interchanging data with each other, to perform a following procedure:
presenting data representative of a purchase offer meant for an intellectual property such that said data can be freely browsed via the communication network;
accepting a sale offer meant for the industrial property and received from a seller's terminal unit;
registering information relating to the intellectual property purchased from the seller and applied for a registration;
presenting a sale offer meant for the intellectual property registered to a buyer's terminal unit; and
accepting a purchase offer meant for the intellectual property and received from a buyer via the buyer's terminal unit.
